(19) United States
(12) Patent Application Publication
(10) Pub. No.: US 2012/0181981 A1
(43) Pub. Date: Jul. 19, 2012

(54) ENERGY SUPPLY UNIT, LAND VEHICLE, REPLACEMENT STATION AND METHOD FOR REPLACEMENT OF AN ENERGY SUPPLY UNIT CONTAINED IN A LAND VEHICLE

(75) Inventors: Mathias Wechlin, Kandern (DE); Andrew Green, Malsburg-Marzell (DE)

(73) Assignee: CONDUCTIX-WAMPFLER AG, Weil am Rhein (DE)

(21) Appl. No.: 13/383,880

(22) PCT Filed: Jul. 8, 2010
(86) PCT No.: PCT/EP2010/059786

§ 371 Date: Mar. 29, 2012

(30) Foreign Application Priority Data
Jul. 14, 2009 (DE) 102009033235.9

(51) Int. Cl. H02J 7/00; B23P 19/04; B60L 1/00

(52) U.S. Cl. 320/108; 307/9.1; 29/402.08

(57) ABSTRACT

The invention relates to an energy supply unit (1; 21) for supplying an onboard electrical system (8) of a land vehicle (26), in particular a wheeled vehicle, with a rechargeable electric energy accumulator (3), a secondary coil (9) connected thereto for the inductive energy transmission between the secondary coil (9), and a primary coil (28) of a charging station, to a land vehicle comprising an onboard electrical system, to a replacement station, and to a method for replacing an energy supply unit contained in a land vehicle. The invention solves the problem of making it possible to achieve a space-saving arrangement of the electrical energy accumulator and secondary coil in the vehicle, charge the electric energy accumulator in the land vehicle and quickly replace the electric energy accumulator, by an energy supply unit (1; 21), which is designed as a replaceable overall unit having a connecting element (6; 23) for connecting to a mating connecting piece (7; 24) disposed on the land vehicle (26) for the energy transmission between the energy supply unit (1; 21) and the onboard system (8), and by a corresponding land vehicle, a corresponding replacement station, and a corresponding method for replacing an energy supply unit contained in a land vehicle.

The invention relates to an energy supply unit according to the preamble of claim 1, to a land vehicle according to the preamble of claim 11 and to a replacement station and to a method for replacement of an energy supply unit contained in a land vehicle.

In the case of known land vehicles, in particular wheeled vehicles such as motor vehicles, it is increasingly proposed that electric motors be used as an additional or sole propulsion motor. To supply these electric motors with electrical energy, the wheeled vehicles, also referred to in the following as vehicles for short, are provided with rechargeable electrical energy stores in the form of a rechargeable vehicle battery. As in the case of a conventional fuel-powered land vehicle, the vehicle battery is discharged by the propulsion of the vehicle and must be “filled up again”, i.e. recharged electrically, after a certain time. For this, the state of the art offers a large number of different solutions which allow immediate charging of the energy stores. However, compared to conventional filling stations for fuel-powered internal combustion engines, electric “filling stations” of this kind have the serious disadvantage that with the electrical energy stores known to date, in particular rechargeable batteries or accumulators, the average charging time up to complete charging of the energy stores is of the order of hours and thus much longer than filling a vehicle tank with liquid or gaseous fuel. However, as users have become accustomed to filling up within a few minutes, this problem represents a serious hindrance to the use of vehicles equipped exclusively with electric propulsion motors.

Solutions already exist to overcome this disadvantage, involving replacement of the discharged vehicle, battery with a charged vehicle battery as rapidly as possible. However, if a vehicle comes to a standstill a distance from a corresponding battery replacement station due to a discharged vehicle battery, replacement of the discharged vehicle battery is not immediately possible due to its great weight. Whereas with fuel-powered vehicles for which if necessary the fuel required to drive on to the nearest filling station can be carried from a filling station to the vehicle in a portable canister, this is not possible with the heavy vehicle batteries weighing dozens of kilos. In this case, the vehicle must be towed to the nearest battery replacement station with a tow truck.

Other solutions for recharging vehicle batteries propose that the vehicle battery can be charged inductively by means of a primary coil arranged on the ground in a charging station and a secondary coil arranged on the underside of the vehicle. Such charging stations can be provided for example in the garage at the home of the owner of the vehicle or in public parking places where the vehicles can either be charged partly by means of a brief charging operation taking a few minutes or fully by means of an extended full charging operation taking several hours. However, as both the vehicle battery and the secondary coil take up a relatively large amount of space in the vehicle and both must be easily accessible from the outside of the vehicle—the vehicle battery for simple and rapid replacement and the secondary coil for good inductive coupling with the primary coil—the space available on the underside of the vehicle, particularly with small or medium sized vehicles, is not sufficient to accommodate both the secondary coil and the replaceable vehicle batteries there. This prevents a combination of both solutions and is also not known from the state of the art.

DE 10 2007 054 396 A1 relates to a known vehicle battery with a helical conductor arrangement located in a side wall of the battery. For charging the battery the charging device has to be arranged as close as possible to the side wall of the battery assuring sufficient coupling with the helical conductor arrangement of the charging device. If the battery is mounted in the vehicles motor compartment this is not possible due to the limited installation space therein, leading to a location of the helical conductor arrangement of the charging device outside the motor compartment. This results in a bad magnetic coupling of the helical conductor arrangement and therefore high spreading losses and transmission losses.

DE 24 10 102 A1 relates to a device for replacing the batteries of battery-driven vehicles with a replacing trolley serving for collecting or releasing of the batteries, which trolley can be moved from a direction perpendicular to the driving direction towards the vehicle fixed in the replacement position. DE 694 25 511 T2 relates to a battery charging and transfer system in which a replaceable vehicle battery could be pushed in the vehicle or pulled out of the vehicle from one side thereof. Both above known devices show the disadvantage that due to pushing from the side the replacement device needs a lot of space and further security provisions have to be provided which prevent the space at the side of the vehicle can be walked-on during battery replacement.

U.S. Pat. No. 5,998,963 A relates to a replacement and charging station for batteries of electrical vehicles. The station shows the disadvantage that the batteries have to be electrically coupled with contacts of the charging station for charging the battery.

Therefore, the underlying object of the present invention is to provide an energy supply unit for supplying a vehicle electrical system of a land vehicle, a land vehicle and a replacement station and a method for replacement of an energy supply unit contained in a land vehicle, which, overcome the above-named disadvantages and allow a space-saving arrangement of electrical energy store and secondary coil in the vehicle and both the charging of the electrical energy store in the land vehicle and the rapid replacement of the electrical, energy store.

The invention achieves this object with an energy supply unit with the features of claim 1, a land vehicle with the features of claim 11, and a replacement station and a method for replacement of an energy supply unit contained in a land vehicle with the features of claims 18 and 22 respectively. Advantageous embodiments and expedient developments of the invention are disclosed in the subordinate claims.

According to the invention, the energy supply unit named initially is characterized in that it takes the form of an exchangeable complete unit with a connecting element for connection with a counterpart connecting element arranged on the land vehicle for transmission of energy between the energy supply unit and the vehicle electrical system. This allows simple insertion and extraction of the energy supply unit in a land vehicle named initially with the characterizing features that it is designed to receive an energy supply unit and exhibits a counterpart connecting element for connection with the connecting element of the energy supply unit. The energy supply unit also makes it possible to charge the land vehicle with short or opportunistic charging operations at charging stations without removing the energy supply unit. In addition, when discharged further, the energy supply unit according to the invention allows rapid replacement with a different completely charged energy supply unit in a replacement station according to the invention. This avoids the long standstill times of the land vehicle required hitherto during charging and the associated waiting times. The integration of the secondary coil and energy store in an exchangeable complete unit also allows easy, contact-free and thus largely hazard-free charging of the energy stores contained in the energy supply unit in a replacement station according to the invention. In addition, the invention allows the replacement of the energy supply unit in a replacement station to be carried out in a completely automated manner since no contact connections have to be made to charging devices to charge the energy stores of the energy supply unit in the replacement station.

In one preferred embodiment the energy supply unit can have as connecting element a vehicle electrical system primary coil for inductive transmission of energy between the vehicle electrical system primary coil and the counterpart connecting element embodied as a vehicle electrical system secondary coil on the land vehicle. Since as a result the energy transmission from a primary coil arranged outside the land vehicle to the energy supply unit and the transmission of energy from the energy supply unit to the vehicle electrical system is carried out inductively, i.e. without contact, no mechanical contacts of any kind are needed to transmit the energy between the energy supply unit and the charging device or vehicle electrical system. Thus, the energy supply unit can be embodied as a completely encased complete unit so that the ingress of dirt, moisture or other objects into the energy supply unit can be safely avoided. In addition, there is no need to take any other protective measures to protect electrical contacts against contact by persons or objects. Such an energy supply unit requires no mechanical moving parts so there is no longer any need for these to be checked regularly for ease of movement and the regular easing of the mechanical moving parts is eliminated.

A further advantageous embodiment of the invention can exhibit at least one coupling element for rapid mechanical connection with an least one counterpart coupling element provided on the land vehicle. This allows the energy supply unit to be connected securely to the vehicle in a simple and rapid manner and also to be detached from it in a rapid and simple manner. This makes it easy to ensure automated replacement of the energy supply unit. To this end, advantageously at least one positioning element can be provided for engagement with at least one counterpart positioning element arranged on the land vehicle according to the invention in order to position the connecting element or elements and the counterpart connecting element or elements easily and precisely in relation to one another when inserting the energy supply unit in the land vehicle.

A replacement station according to the invention for replacement of a first energy supply unit contained in a land vehicle according to the invention by a second energy supply unit held in a store of the replacement station exhibits a changing device arranged on the ground for extraction of the first energy supply unit from the land vehicle and for transferring the first energy supply unit to a transporting device for transporting the first energy supply unit into the store and the second energy supply unit from the store to the changing device. This allows rapid replacement of the energy supply unit which takes roughly the same time as a filling operation with a fuel-powered land vehicle.

In order to be able to rapidly and easily recharge a discharged energy supply unit extracted from the land vehicle, advantageously the store of the replacement station can be provided with one or more receptacles each with a charging primary coil for inductive transmission of energy between the charging primary coil and the secondary coil of the energy supply unit stored in the receptacle.

In a space-saving embodiment which is advantageous for replacement, the changing device can exhibit a lifting device which has a vertically travelling support for the energy supply unit and is arranged in a pit running between two tracks for a two-track land vehicle. This allows an energy supply unit arranged on the underside of the land vehicle to be extracted rapidly and safely. In addition, the further replacement can then be carried out below ground so there is no major requirement for space above ground. This means that existing fuel filling stations can easily be converted into replacement stations without additional space being required above ground. Since the large tanks arranged in the ground in conventional filling stations have to be removed anyway, the excavation work also remains within bounds.

In one preferred embodiment, a control device can be provided for automated changing of the energy supply unit so as to require the minimum amount of operating personnel and endanger the existing operating personnel as little as possible.

A method according to the invention for replacement of a first energy supply unit contained in a land vehicle by a second energy supply unit comprises the following steps: a) positioning of the land vehicle in a changing area of a changing device, b) connection of the first energy supply unit by the changing device, c) opening of the mechanical connection between the first energy supply unit and the land vehicle, d) extraction of the first energy supply unit from the land vehicle with the changing device, e) transportation of the first energy supply unit out of the changing area, beforehand, at the same time or afterwards, f) loading of the changing device (30) with the second energy supply unit, g) fitting of the second energy supply unit with the changing device in the land vehicle, and at the same time or afterwards h) production of the mechanical connection between the second energy supply unit and the land vehicle. This allows the replacement of an energy supply unit to be carried out rapidly and easily, and in one advantageous embodiment of the method at least steps b) to h) can be automated.

Further particular features and advantages of the invention will become apparent from the following description of a preferred embodiment example with reference to the drawings in which:

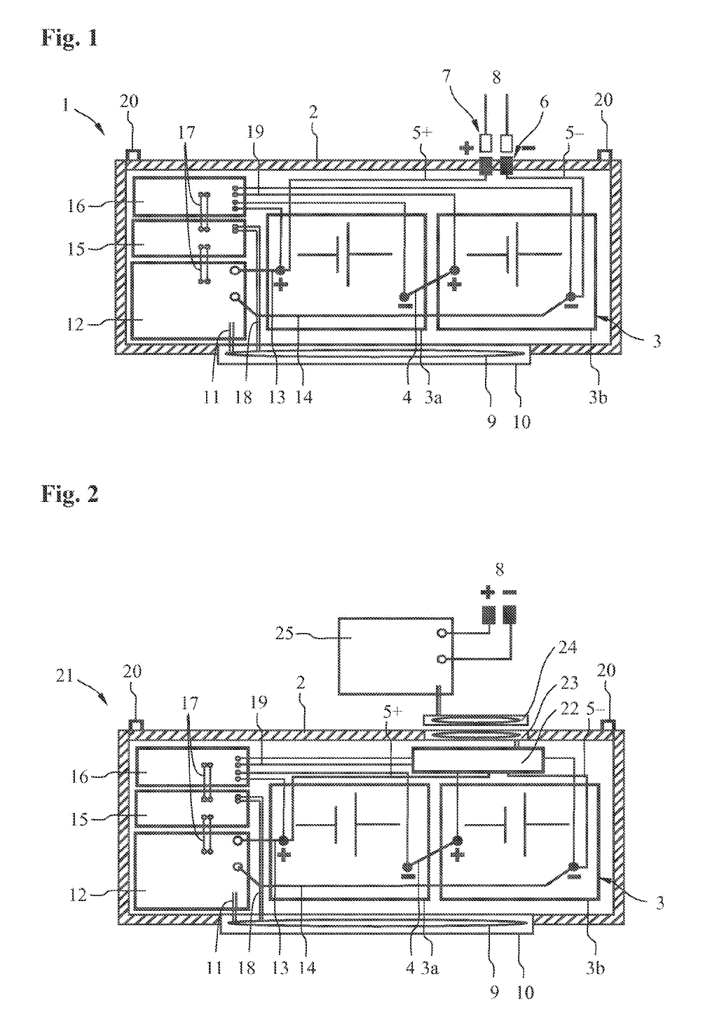

FIG. 1 shows a diagrammatic view of a first embodiment of an energy supply unit according to the invention shown partially opened,

FIG. 2 shows a diagrammatic view of a second embodiment of an energy supply unit according to the invention shown partially opened,

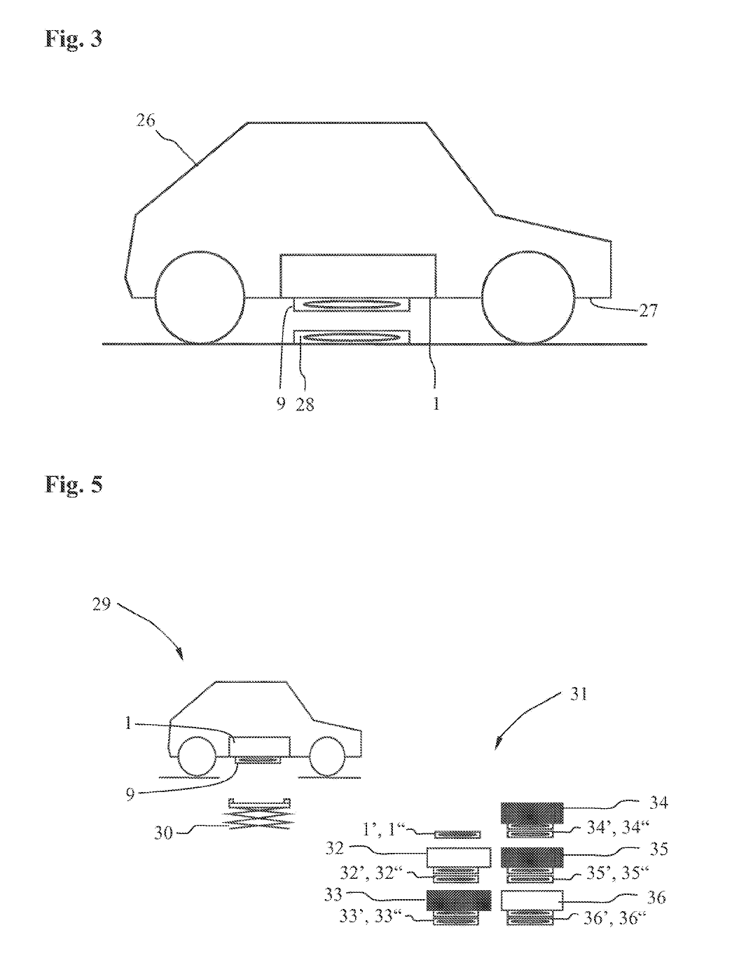

FIG. 3 shows a diagrammatic view of a charging operation of an energy supply unit according to the invention in a land vehicle according to the invention,

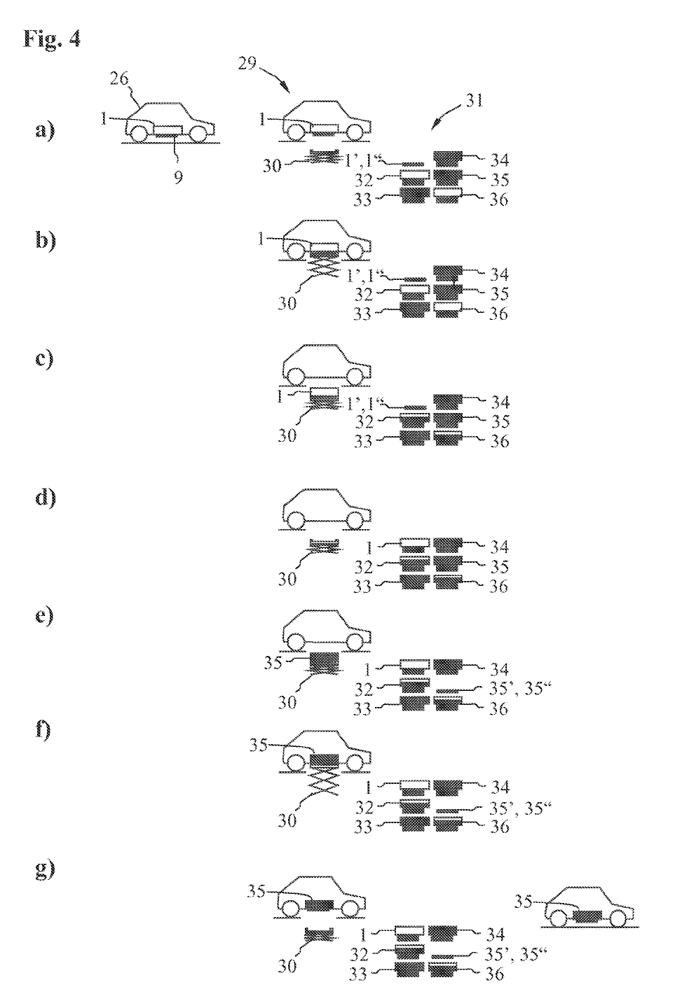

FIG. 4 a-h shows a diagrammatic illustration of a replacement station according to the invention during different steps of the method according to the invention for replacement of an energy supply unit contained in a land vehicle,

FIG. 5 shows a detail view of the replacement station from FIG. 4 a).

FIG. 1 shows a first embodiment of an energy supply unit 1 according to the invention, with a sealed box-shaped housing 2 of the energy supply unit 1 shown partially cut away for a better understanding of the invention. The housing 2 is made of a preferably acid-resistant material in order to prevent any escape of toxic battery acids or vapours in the event of damage to energy stores 3 contained therein. The housing can also have a different form to that shown in the drawings.

In the present embodiment, the energy store 3 consists of a rechargeable first battery 3a and second battery 3b, each with a positive terminal + and negative terminal −. Instead of these, other energy stores can be used for storage of electrical energy, for example so-called super-caps or a combination of rechargeable batteries and super-caps. To provide a desired supply voltage from the energy store 3, the negative terminal of the first battery 3a is connected via a series lead 4 to the positive terminal of the second battery 3b. From the positive terminal of the first battery 3a and the negative terminal of the second battery 3b connecting leads 5+ and 5− run to a connecting element in the form of a contact connector 6. In FIG. 1, the contacts of the contact connector 6 are connected in electrically conducting manner to a counterpart connecting element in the form of a contacting vehicle electrical system connector 7 of a vehicle electrical system 8 which is only indicated in FIG. 1. Thus, energy can be transmitted between the energy store 3 and the vehicle electrical system 8.

To charge the energy store 3 from outside the vehicle, the invention provides a secondary coil 9 which is fixed on the housing 2 or integrated in it and which in the present case is embedded in its own cast coil former 10. The coil former 10 prevents direct contact with the secondary coil 9. The secondary coil 9 is connected with a controller or rectifier 12 through a power connection 11. In place of the single circular secondary coil 9 shown in the present case, other forms or a plurality of secondary coils can also be provided.

The positive output of the rectifier 12 is connected via a positive charging lead 14 with the positive terminal of the first battery 3a and the negative output of the rectifier 12 is connected via a negative charging lead 14 with the negative terminal of the second battery 3a in an electrically conducting manner. The energy supplied by the secondary coil 9 in the form of alternating voltage and alternating current is converted into the direct voltage and direct current required for the energy store 3 and the vehicle electrical system 8 with the rectifier 12. The design and manner of operation of controllers or rectifiers 12 of this kind is well known.

In addition, the energy supply unit 1 comprises a communications interface 15 and a battery management system 16, both of which are supplied with the required supply voltage by the rectifier 12 via a looped-through supply lead 17.

The communications interface 15 is connected with the secondary coil 9 via a communications lead 18 in order to evaluate communications signals modulated on the energy transmission signal for example. This allows the energy supply unit 1 to be addressed from the outside through the secondary coil 9. In the same way, the communications interface 15 can transmit data from the energy supply unit 1 or when necessary from the vehicle electrical system 8 in the reverse direction through the secondary coil 9 to the exterior.

The battery management system 16 is connected with the positive and negative terminals of the batteries 3a, 3h of the energy store 3 by means of four battery management leads 19 and monitors the state of charge of the batteries 3a, 3b and controls the charging and where necessary the discharging of the batteries 3a, 3b. The rectifier 12, the communications interface 15 and the battery management system 16 are connected with one another to exchange data so that for example the battery management system 16 can control the feeding of energy from the rectifier 12 into the batteries 3a, 3b. In contrast, this allows the communications interface 15 to transmit the data determined in the energy supply unit 1 and where necessary in the vehicle electrical system 8 inductively to the exterior in order for example to inform a charging station of the energy requirement and the parameters of the energy store 3 and the energy supply unit 1.

In order to be able to fasten the energy supply unit 1 securely in a land vehicle, two coupling elements are provided in the form of lugs 20 arranged on the housing and protruding from it. The lugs 20 engage on the land vehicle in recesses in which counterpart coupling elements in the form of moving pins can be passed automatically through the lugs 20 in order to secure the energy supply unit 1 to the land vehicle in all operating situations.

The alternative embodiment of an energy supply unit 21 according to the invention shown in FIG. 2 differs from the energy supply unit 1 in FIG. 1 only in the nature of the energy transmission connection to the vehicle electrical system 8, for which reason the differences above all are explained in the following. Therefore, the same parts are designated with the same references as above.

In contrast to the embodiment of the energy supply unit 1 in FIG. 1, in the energy supply unit 21 according to FIG. 2 the connecting leads 5+ and 5− are connected not with the electrically conducting contact connection 6 for making contact with the corresponding vehicle electrical system connection 7, but with an inverter 22. The inverter 22 converts the direct voltage and direct current provided by the energy store 3 into an alternating voltage and alternating current to supply a vehicle electrical system primary coil 23 connected to its output as connecting element. This transmits energy inductively to a counterpart connecting element in the form of a vehicle electrical system secondary coil 24 to supply energy to the vehicle electrical system 8. For this, on the vehicle side a rectifier 25 is connected between the vehicle electrical system secondary coil 24 and the vehicle electrical system 8, which converts the alternating voltage and current transmitted via the coil arrangement 23, 24 back into the direct voltage and current required for the vehicle electrical system 8.

This means that no electrical contacts of any sort are needed any more so that the energy supply unit 21 can be made completely encased. Thus, there are no more mechanically actuated parts, which means a high level of freedom from maintenance and thus long maintenance intervals. In addition, there is no risk of danger to persons or objects through contact with the connection contacts 6 of the embodiment in FIG. 1 so that corresponding protection of the connection contacts 6 is unnecessary. This means that the increased expense due to the vehicle electrical system primary coil 23, vehicle electrical system secondary coil 24 plus the inverter 22 and rectifier 25 is justified. The energy loss caused by such an arrangement remains within acceptable limits due to the high efficiency of today's rectifiers and inverters.

FIG. 3 shows a land vehicle 26 according to the invention on the underside 27 of which is attached an energy supply unit 1 according to the invention. The land vehicle 26 is located over a primary coil 28 of a charging station for charging of the energy stores 3 of the energy supply unit 1 in the installed state.

FIG. 4 shows a diagrammatic illustration of a replacement station 29 according to the invention during different steps of the method according to the invention on the basis of which the method according to the invention for replacement of a first energy transmission unit 1 arranged in a land vehicle 26 is explained in the following.

FIG. 4 a) on the left shows the vehicle 26 driving into the replacement station 29 with an almost completely discharged energy supply unit 1. If the vehicle 26 is to be driven further without a lengthy waiting time, the energy supply unit 1 must be changed rapidly in the replacement station 29. FIG. 5 shows the replacement station 29 in FIG. 4 a) in an enlarged illustration.

The replacement station 29 exhibits a lifting device arranged underneath a changing area a changing device 30 which is arranged in a pit under tracks of the vehicle 26 and takes the form of a scissor lever arrangement. A hydraulic drive not shown in FIG. 4 raises the scissor lever arrangement from the position in FIG. 4 a) to the extended position shown in FIG. 4 b). Other suitable drives known per se can also be used in place of a hydraulic drive. In the replacement station 29 a plurality of energy supply units 32 to 36 according to the invention are stored in a store 31 and are charged there in associated receptacles with charging primary coils. The receptacle 1′, 32′ to 36′ with respective charging primary coils 1″, 32″ to 36″ for the respective energy supply units 1, 32 to 36 are shown in detail by way of example in FIG. 5. The energy supply units 32 and 36 shown unfilled in FIG. 4 are discharged and must be recharged whereas the energy supply units 33 to 35 are charged and available immediately for replacement. When the charged energy supply units 32 to 35 are stored for an extended period, these must be recharged from time to time by means of the appropriate charging primary coils 32″ to 35″.

After the vehicle 26 has been driven into the changing area of the changing device 30 and positioned as shown in the middle of FIG. 4 a), the changing device 30 is moved up to the energy supply unit 1 from below and brought into contact with the latter in FIG. 4 b). Then the mechanical connection between the energy supply unit 1 and the land vehicle 26 is opened, the energy supply unit 1 is then only held by the changing device 30. Then the changing device 30 moves down from the position shown in FIG. 4 b) to the position shown in FIG. 4 c). This can either be driven or be produced by the weight of the energy supply unit 1.

As can also be seen in FIG. 4 c), the energy supply units 32 and 36 are half recharged in the intervening time. Then the energy supply unit 1 is extracted from the changing device 30 and transported by means of a transport device not shown, for example a conveyor belt, into the store 31 to the free position at the top on the left shown in FIG. 4d). There the energy supply unit 1 is placed in a receptacle 1′ with a charging primary coil 1″ (see FIG. 5) for inductive transmission of energy to the secondary coil 9 of the energy supply unit 1. As soon as the energy supply unit 1 is placed in position, its charging begins automatically.

Then, the energy supply unit 35 is transported by means of the transport device from the store 31 to the changing device 30 where it is placed on the changing device 30 in FIG. 4 e). To speed up replacement further, the fully charged energy supply unit 35 can be transported to the changing device 20 and placed there in a standby position before or while the land vehicle 26 is driven in or while the energy supply unit 1 is extracted from the land vehicle 26. For example, the fully charged energy supply unit 35 can advantageously be made ready at the changing device 20 on the basis of a request signal sent by the land vehicle 26 to the replacement station 29 before or while the land vehicle 26 is driven in. In addition, the changing device can be designed for example with two lifting devices 30, so that the charged energy supply device 35 is inserted into the land vehicle 26 immediately after extraction of the discharged energy supply unit 1 from the land vehicle 26, and the discharged energy supply unit 1 is only transported away afterwards in order to allow the fastest possible exchange of energy supply units 1 and 35.

Then, the energy supply unit 35 is raised on the changing device 30 up to the land vehicle 26 and fitted in it in FIG. 4 f). Then the energy supply unit 35 is coupled securely to the land vehicle 26 by means of its coupling elements 20 and the corresponding counterpart coupling elements on the land vehicle 26. Afterwards, as can be seen in FIG. 4 g) in the middle, the changing device 30 is returned to its lowered position while the land vehicle 26 drives out of the replacement station 29 with the completely charged energy supply unit 35.

In view of the fact that the replacement of the energy supply unit 1 takes place fully automatically in the embodiment shown in FIG. 4, the replacement operation described above takes no longer than a normal filling operation with fuel-powered land vehicles. The specific design of the energy supply unit according to the invention allows not only rapid replacement and removal from the vehicle 26 but also the immediate recharging in the replacement station 29 without the need to carry out additional operations or make electrical contacts.

1. Energy supply unit for supplying a vehicle electrical system of a land vehicle, in particular a wheeled vehicle, with a rechargeable electrical energy store and a secondary coil connected to the latter for inductive transmission of energy between the secondary coil and a primary coil of a charging station, wherein the energy supply unit takes the form of an exchangeable complete unit with a connecting element for connection with a counterpart connecting element arranged on the land vehicle for transmission of energy between the energy supply unit and the vehicle electrical system.

2. Energy supply unit according to claim 1, wherein the energy store is provided in and the secondary coil is provided in or on a housing.

3. Energy supply unit according to claim 1 wherein the energy supply unit exhibits at least one coupling element for rapid mechanical connection with at least one counterpart coupling element provided on the land vehicle.

4. Energy supply unit according to claim 3, wherein the coupling element is formed by a lug protruding from the housing and/or by a pin arranged in a recess in the housing in such a way that it can be embraced.

5. Energy supply unit according to claim 1, wherein the energy supply unit exhibits at least one positioning element for engagement in at least one counterpart positioning element arranged on the land vehicle.

6. Energy supply unit according to claim 1, wherein the energy store is connected with the secondary coil via a rectifier arranged in the housing.

7. Energy supply unit according to claim 1, wherein a control unit is provided for monitoring and/or controlling the secondary coil, the energy store, the charging and discharging operation of the energy store and/or other components provided in the energy supply.

8. Energy supply unit according to claim 1, wherein the connecting element is an electrically conducting connector for making contact with the counterpart connecting element in the form of an electrically conducting vehicle electrical system connector.

9. Energy supply unit according to claim 1, wherein the connecting element is a vehicle electrical system primary coil for inductive transmission of energy between the vehicle electrical system primary coil and the counterpart connecting element in the form of the vehicle electrical system secondary coil.

10. Energy supply unit according to claim 9, wherein the vehicle electrical system primary coil is connected with the energy store via an inverter.

11. Land vehicle, in particular wheeled vehicle, with a vehicle electrical system, wherein the land vehicle is designed to receive an energy supply unit according to claim 1 and exhibits a counterpart connecting element for connection with the connecting element of the energy supply unit.

12. Land vehicle according to claim 11, wherein the land vehicle exhibits at least one counterpart coupling element for rapid mechanical connection with at least one coupling element of the energy supply unit.

13. Land vehicle according to claim 12, wherein the counterpart coupling element can be actuated to automatically open and release the mechanical connection.

14. Land vehicle according to claim 11, wherein the land vehicle exhibits at least one counterpart positioning element for engagement in at least one positioning element of the energy supply unit.

15. Land vehicle according to claim 11, wherein the counterpart connecting element is an electrically conducting vehicle electrical system connector for making contact with the connecting element in the form of an electrically conducting connector.

16. Land vehicle according to claim 11 wherein the counterpart connecting element is a vehicle electrical system secondary coil for inductive transmission of energy between the vehicle electrical system secondary coil and the connecting element in the form of a vehicle electrical system primary coil.

17. Land vehicle according to claim 16, wherein the vehicle electrical system secondary coil is connected with the vehicle electrical system via a vehicle electrical system rectifier.

18. Replacement station for replacement of a first energy supply unit according to claim 1 contained in a land vehicle by a second energy supply unit held in a store of the replacement station, with a changing device arranged on the ground for extraction of the first energy supply unit from the land vehicle and for transferring the first energy supply unit to a transporting device for transporting the first energy supply unit into the store and the second energy supply unit from the store to the changing device.

19. Replacement station according to claim 18, wherein in the store there is at least one receptacle with a charging primary coil for inductive transmission of energy between the charging primary coil and the secondary coil of an energy supply unit stored in the receptacle.

20. Replacement station according to claim 18, wherein the changing device exhibits a lifting device which has a vertically travelling support for the energy supply unit and is arranged in a pit running between two tracks for a two-track land vehicle.

21. Replacement station according to claim 18, wherein a control device is provided for automatically changing an energy supply unit of a land vehicle in the replacement station.

22. Method for replacement of a first energy supply unit according to claim 1 contained in a land vehicle by a second energy supply unit, in particular in a replacement station, with the following steps:
a) positioning of the land vehicle in a changing area of a changing device,
b) connection of the first energy supply unit by the changing device,
c) opening of the mechanical connection between the first energy supply unit and the land vehicle,
d) extraction of the first energy supply unit from the land vehicle with the changing device,
e) transportation of the first energy supply unit out of the changing area, beforehand, at the same time or afterwards
f) loading of the changing device with the second energy supply unit,
g) fitting of the second energy supply unit with the changing device in the land vehicle, and at the same time or afterwards
h) production of the mechanical connection between the second energy supply unit and the land vehicle.

23. Method according to claim 22, wherein the energy store of the first energy supply unit is partly or fully discharged and the energy store of the second energy supply unit is fully charged.

24. Method according to claim 22 wherein at least steps b) to h) are automated.

25. Method according to claim 22, wherein the electrical or inductive connection between the first energy supply unit and the land vehicle is separated immediately before, during or immediately after step c).

26. Method according to claim 22, wherein the electrical or inductive connection between the second energy supply unit and the land vehicle is produced during or immediately after step h).
